(19) United States
(12) Patent Application Publication
(10) Pub. No.: US 2024/0281313 A1
(43) Pub. Date: Aug. 22, 2024

(54) SYSTEM FOR ANALYZING ABNORMAL DATA AND OPERATING METHOD THEREOF

(71) Applicant: SEMES CO., LTD., Chungcheongnam-do (KR)

(72) Inventors: Hojune LEE, Seongnam-si (KR); Donghyun JUN, Seongnam-si (KR)

(21) Appl. No.: 18/582,808

(22) Filed: Feb. 21, 2024

(30) Foreign Application Priority Data
Feb. 21, 2023 (KR) 10-2023-0023150

(51) Int. Cl. G06F 11/07; G06F 11/30

(52) U.S. Cl. CPC G06F 11/0751; G06F 11/3072

(57) ABSTRACT

An operating method of a system for analyzing abnormal data includes generating an anomaly detection model by using a training data set including a plurality of pieces of multivariate time-series data, comparing first time-series data input to the anomaly detection model with second time-series data output from the anomaly detection model through an operation on the first time-series data, determining whether or not the first time-series data includes abnormal data, on the basis of the comparison between the first time-series data and the second time-series data, comparing a first plurality of data elements included in the first time-series data with a second plurality of data elements included in the second time-series data, and detecting at least one data element on the basis of a result of comparing the first plurality of data elements with the second plurality of data elements.

### CROSS-REFERENCE TO RELATED APPLICATION

This application is based on and claims priority under 35 U.S.C. § 119 to Korean Patent Application No. 10-2023-0023150, filed on Feb. 21, 2023, in the Korean Intellectual Property Office, the disclosure of which is incorporated by reference herein in its entirety.

### BACKGROUND

### 1. Field

The disclosure relates to a system for analyzing abnormal data and an operating method thereof, and more particularly, to a system for analyzing abnormal data by using an artificial intelligence technology and an operating method thereof.

### 2. Description of the Related Art

In order to diagnose errors occurring in processes, existing methods have been used to detect abnormal data by using artificial neural networks trained with normal data.

In more detail, existing detection models using artificial neural networks may be trained to extract features by inputting and encoding normal data, decode the extracted features, and output the same data as the input normal data. Subsequently, when abnormal data is input into the existing detection models, the existing detection models may output data from which some of the input abnormal data is lost, and when a difference between the output data and the input data is greater than or equal to a certain level, the existing detection models may detect the corresponding input data as abnormal data.

### SUMMARY

An existing detection model may detect corresponding input data as abnormal data when a difference between the input data and output data is greater than or equal to a certain level, but may not identify whether or not the corresponding input data is detected as abnormal data due to any element from among a plurality of elements included in the input data.

Accordingly, when monitoring time-series data generated in a process on the basis of the existing detection model, the occurrence of an error in the process due to the detection of abnormal data may be detected, but particularizing whether or not repair is needed for a certain process may not be easy.

Provided are an analysis system and an operating method thereof, which may provide detailed feedback to a user by analyzing abnormal data in a process and particularizing a process element and/or an equipment element in which an error occurs.

In addition, problems to be solved by the spirit of the disclosure are not limited to the problems mentioned above, and other problems may be clearly understood by one of ordinary skill in the art from the following description.

Additional aspects will be set forth in part in the description which follows and, in part, will be apparent from the description, or may be learned by practice of the presented embodiments of the disclosure.

According to an aspect of the disclosure, an operating method of a system for analyzing abnormal data includes generating an anomaly detection model by using a training data set including a plurality of pieces of multivariate time-series data, comparing first time-series data input to the anomaly detection model with second time-series data output from the anomaly detection model through an operation on the first time-series data, determining whether or not the first time-series data includes abnormal data, on the basis of the comparison between the first time-series data and the second time-series data, when the first time-series data is determined to include the abnormal data, comparing a first plurality of data elements included in the first time-series data with a second plurality of data elements included in the second time-series data, and detecting at least one data element on the basis of a result of comparing the first plurality of data elements with the second plurality of data elements.

The first plurality of data elements and the second plurality of data elements may each include a plurality of time-series data respectively acquired by a plurality of sensors in a process.

The operating method may further include calculating, on the basis of a database related to the process, an abnormality cause possibility of at least one of a process element and an equipment element corresponding to the detected at least one data element.

The database may include at least one of an average defect rate, an average maintenance period, an average exchange period, and average sensitivity to temperature and humidity for each of a plurality of process operations.

The operating method may further include calculating the abnormality cause probability for the detected at least one data element by applying a weight to the database.

The operating method may further include generating and outputting feedback data regarding the detected at least one data element when the calculated abnormality cause probability is greater than or equal to a reference value.

The feedback data may include at least one of whether or not at least one of the process element and the equipment element corresponding to the detected at least one data element is abnormal and management information regarding at least one of the process element and the equipment element.

The operating method may further include determining that the first time-series data includes the abnormal data, when a reconstruction error calculated on the basis of the comparison between the first time-series data and the second time-series data is greater than or equal to a reference value.

According to another aspect of the disclosure, a system for analyzing abnormal data includes a detection apparatus configured to generate, in a process, multivariate time-series data via a plurality of sensors, and an analysis apparatus including at least one processor, wherein the processor is configured to generate an anomaly detection model by using a training data set including a plurality of pieces of multivariate time-series data, compare first time-series data, which is generated via the detection apparatus and input to the anomaly detection model, with second time-series data output from the anomaly detection model through an operation on the first time-series data, determine whether or not the first time-series data includes abnormal data, on the basis of the comparison between the first time-series data and the second time-series data, when the first time-series data is determined to include the abnormal data, compare a first plurality of data elements included in the first time-series data with a second plurality of data elements included in the second time-series data, and detect at least one data element on the basis of a result of comparing the first plurality of data elements with the second plurality of data elements.

The first plurality of data elements and the second plurality of data elements may include a plurality of time-series data respectively acquired by a plurality of sensors of the detection apparatus in a process.

The processor may be further configured to calculate, on the basis of a database related to the process, an abnormality cause possibility of at least one of a process element and an equipment element corresponding to the detected at least one data element.

The database may include at least one of an average defect rate, an average maintenance period, an average exchange period, and average sensitivity to temperature and humidity for each of a plurality of process operations.

The processor may be further configured to calculate the abnormality cause probability for the detected at least one data element by applying a weight to the database.

The processor may be further configured to generate and output feedback data regarding the detected at least one data element when the calculated abnormality cause probability is greater than or equal to a reference value.

The processor may be further configured to determine the first time-series data to be abnormal data when a reconstruction error calculated on the basis of the comparison between the first time-series data and the second time-series data is greater than or equal to a reference value.

According to another aspect of the disclosure, an apparatus for analyzing abnormal data includes a communicator configured to receive data by establishing communication with outside, and at least one processor, wherein the processor is configured to generate an anomaly detection model by using a training data set including a plurality of pieces of multivariate time-series data, input first time-series data received via the communicator to the anomaly detection model, and acquire second time-series data output from the anomaly detection model through an operation on the first time-series data, determine whether or not the first time-series data includes abnormal data, on the basis of comparison between the first time-series data and the second time-series data, when the first time-series data is determined to include the abnormal data, compare a first plurality of data elements included in the first time-series data with a second plurality of data elements included in the second time-series data, and detect at least one data element on the basis of a result of the comparison between the first plurality of data elements and the second plurality of data elements.

The processor may be further configured to calculate, on the basis of a database related to a process, an abnormality cause possibility of at least one of a process element and an equipment element corresponding to the detected at least one data element.

The database may include at least one of an average defect rate, an average maintenance period, an average exchange period, and average sensitivity to temperature and humidity for each of a plurality of process operations.

The processor may be further configured to generate and output feedback data regarding the detected at least one data element when the calculated abnormality cause probability is greater than or equal to a reference value.

The processor may be further configured to determine the first time-series data to be abnormal data when a reconstruction error calculated on the basis of the comparison between the first time-series data and the second time-series data is greater than or equal to a reference value.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a block diagram of a system for analyzing abnormal data, according to an embodiment;

FIG. 2 illustrates a flowchart in which a system for analyzing abnormal data detects a data element, according to an embodiment;

FIG. 3 illustrates an example view illustrating a method of generating an anomaly detection model, according to an embodiment;

FIG. 4 illustrates an example view in which abnormal data is input to the anomaly detection model of FIG. 3;

FIG. 5 illustrates an example view of a plurality of data elements included in time-series data, according to an embodiment;

FIG. 6 illustrates a flowchart in which a system for analyzing abnormal data generates feedback data, according to an embodiment; and

FIG. 7 illustrates a block diagram of an apparatus for analyzing abnormal data, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments will be described in detail with reference to the accompanying drawings. Embodiments are provided to one of ordinary skill in the art to more fully describe the disclosure, and the following embodiments may be modified in various different forms, and the scope of the disclosure is not limited to the following embodiments. Rather, these embodiments are provided so that the disclosure will be thorough and complete, and will fully convey the spirit of the disclosure to one of ordinary skill in the art.

In the following description, when a component is referred to as being “connected to” or “coupled to” another component, it may be directly connected or coupled to the other component or intervening components may also be present. Similarly, when a component is referred to as being “on” another component, it may be directly on the other component, or intervening components may also be present. In addition, the structure or size of each component in the drawing is exaggerated for convenience and clarity of description, and portions unrelated to the description are omitted. Like reference numerals in the drawings denote like components, and thus their description will be omitted. Meanwhile, the terms used herein are only for the purpose of describing the disclosure, and are not intended to limit the meaning or to limit the scope of the disclosure defined by claims.

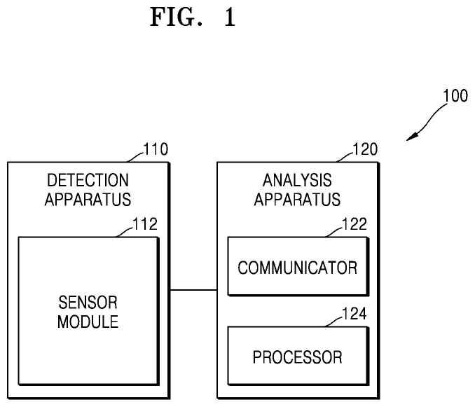

FIG. 1 illustrates a block diagram of a system for analyzing abnormal data, according to an embodiment.

Referring to FIG. 1, a system 100 (hereinafter, referred to as an analysis system 100) for analyzing abnormal data may include a detection apparatus 110 and an analysis apparatus 120. However, the internal structure of the analysis system 100 is not limited to that shown in FIG. 1. One of ordinary skill in the art related to the present embodiment may understand that other components may be further added to the analysis system 100 shown in FIG. 1 according to the design thereof.

In an embodiment, the detection apparatus 110 may collect data regarding a process via a sensor module 112. For example, the process may include semiconductor equipment used in a semiconductor process, display equipment used in a display process, and the like, and may be data regarding an operation of each equipment during the process. The process of the present disclosure may be an operation for product production performed in one or more pieces of equipment, and the data regarding the process may include all types of data collected in the production operation performed in the one or more pieces of equipment.

In an embodiment, the sensor module 112 may generate data related to the process by including a plurality of sensors. For example, the sensor module 112 may generate, via the plurality of sensors, torque, speed, and acceleration data of a motor, internal and external vibration data, temperature data, time data, atmospheric pressure data, pressure data, slope data, current data, and the like that are included in the process.

In an embodiment, the sensor module 112 may generate multivariate time-series data. Here, the multivariate time-series data may be collected at regular intervals over time, and may refer to data including sensing values acquired by the plurality of sensors for each time unit. For example, the sensor module 112 may generate, via the plurality of sensors, the multivariate time-series data by collecting the speed data, temperature data, vibration data, and pressure data of the motor at regular time intervals.

In an embodiment, the analysis apparatus 120 may include a communicator 122 and a processor 124. The components of the analysis apparatus 120 according to an embodiment are not limited thereto, and other components may be added or at least one component may be omitted, according to embodiments.

In an embodiment, the communicator 122 may include at least one component for receiving data by establishing communication with the outside. For example, the analysis apparatus 120 may receive, via the communicator 122, the multivariate time-series data generated by the detection apparatus 110.

In an embodiment, the communicator 122 may include a short-range wireless communication unit and a wireless communication unit.

For example, the short-range wireless communication unit may include a Bluetooth communication unit, a Bluetooth low energy (BLE) communication unit, a near field communication unit, a wireless local area network (WLAN) communication unit, a Zigbee communication unit, an infrared data association (IrDA) communication unit, a Wi-Fi direct communication unit, an ultra wideband (UWB) communication unit, an Ant+ communication unit, and the like, but is not limited thereto.

As another example, the wireless communication unit may include a cellular network communication unit, an Internet communication unit, computer network (e.g., a LAN or a WAN) communication unit, and the like, but is not limited thereto.

In an embodiment, the processor 124 may generate an anomaly detection model on the basis of the multivariate time-series data received via the communicator 122. In more detail, the processor 124 may generate the anomaly detection model by training a network function by using a training data set including a plurality of pieces of multivariate time-series data.

For example, the anomaly detection model may be generated on the basis of data acquired via the sensor module 112 of the detection apparatus 110 when the process is in a normal state. In other words, when the multivariate time-series data, which is acquired via the sensor module 112 when the process is in the normal state, is input into an auto-encoder, a network function of the auto-encoder may be trained to generate the same output data as input data by extracting features by encoding the multivariate time-series data by the auto-encoder and decoding the extracted features.

In an embodiment, the processor 124 may determine whether or not first time-series data includes abnormal data, on the basis of the generated anomaly detection model.

In more detail, the generated anomaly detection model may be generated on the basis of the data acquired via the sensor module 112 when the process is in the normal state to extract features from normal data and reconstruct data on the basis of the extracted features.

Accordingly, when the first time-series data including the abnormal data is input into the anomaly detection model, a pattern of the abnormal data may not be learned by the anomaly detection model, and thus, data having an abnormal pattern with a missing portion may be output. The anomaly detection model may extract, from the abnormal data, a feature in which a portion of an abnormal pattern is missing. In addition, the anomaly detection model may output second time-series data that is data reconstructed on the basis of the feature in which the portion of the abnormal pattern is missing. Here, the second time-series data may be output as normal data due to missing of the abnormal data.

The processor 124 may determine whether or not the input first time-series data includes abnormal data by comparing the first time-series data (i.e., data including abnormal data) input into the anomaly detection model with the second time-series data (i.e., reconstructed data) output from the anomaly detection model.

For example, the processor 124 may calculate a reconstruction error between the first time-series data and the second time-series data, and, when the calculated reconstruction error value is greater than or equal to a reference value, determine that the first time-series data includes the abnormal data.

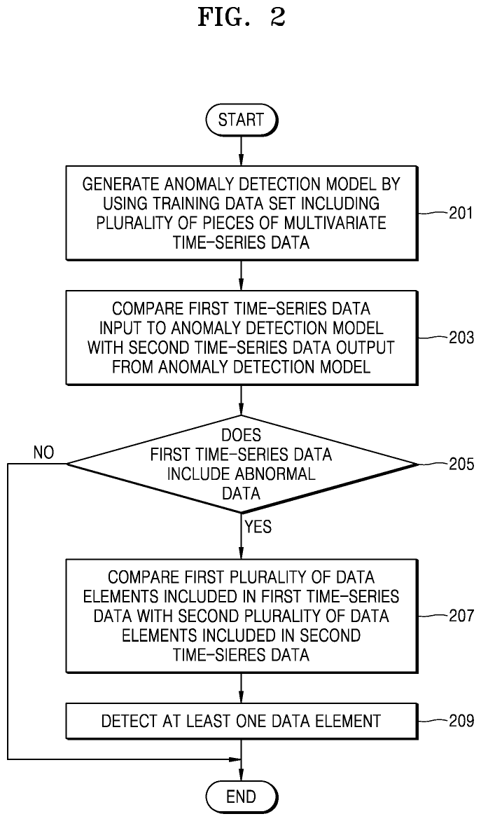

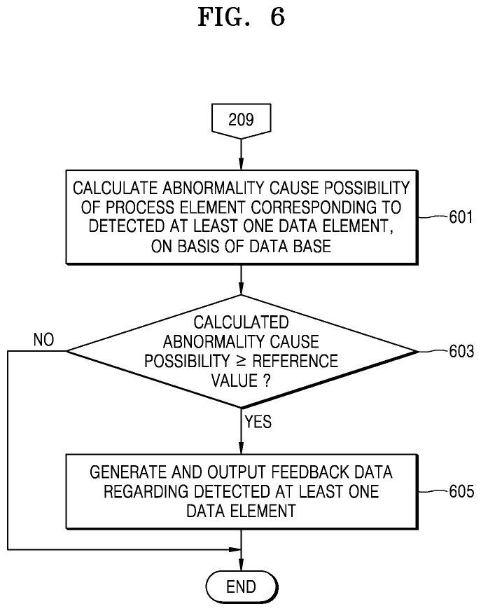

In an embodiment, the processor 124 may compare, for each data element, the first time-series data determined to be the abnormal data with the second time-series data which is normal data and detect at least one data element having a difference. A detailed description thereof is described below with reference to FIG. 2. In addition, the processor 124 may generate feedback data by calculating an abnormality cause possibility for the detected at least one data element. A detailed description thereof is described below with reference to FIG. 6.

FIG. 2 illustrates a flowchart in which a system for analyzing abnormal data detects a data element, according to an embodiment. The detection method of FIG. 2 may be performed by the analysis apparatus 120 of the system 100 for analyzing abnormal data of FIG. 1, and thus, the description, which corresponds to, is the same as, or is similar to the above description, may be omitted.

Referring to FIG. 2, in operation 201, a processor (e.g., the processor 124 of FIG. 1) of the analysis apparatus 120 may train an anomaly detection model by using a training data set including a plurality of pieces of multivariate time-series data. Here, the multivariate time-series data may refer to time-series data generated via a plurality of sensors in a normal state process.

According to an embodiment, in operation 203, the processor 124 may compare first time-series data input into the anomaly detection model with second time-series data output from the anomaly detection model. For example, the processor 124 may compare the first time-series data with the second time-series data by calculating a reconstruction error between the first time-series data and the second time-series data. The reconstruction error may refer to a difference between input data and output data when the input data for a network function is compressed by an encoder, and then reconstructed by a decoder and output.

In an embodiment, the processor 124 may preset a reference value for the reconstruction error for determining the input data for the network function of the anomaly detection model as abnormal data.

According to an embodiment, in operation 205, the processor 124 may determine whether or not the first time-series data includes abnormal data. For example, when the reconstruction error between the first time-series data input into the anomaly detection model and the second time-series data output from the anomaly detection model is greater than or equal to the preset reference value, the processor 124 may determine that the first time-series data includes the abnormal data. As another example, when the reconstruction error between the first time-series data and the second time-series data is less than the preset reference value, the processor 124 may determine that the first time-series data does not include the abnormal data.

According to an embodiment, when the first time-series data is determined to include the abnormal data, in operation 207, the processor 124 may compare, for each data element (e.g., for each sensor), a first plurality of data elements included in the first time-series data with a second plurality of data elements included in the second time-series data.

Here, the first plurality of data elements may refer to pieces of time-series data obtained by dividing the first time-series data for respective sensors, and the second plurality of data elements may refer to pieces of time-series data obtained by dividing the second time-series data for respective sensors. For example, when the first time-series data refers to multivariate time-series data obtained from a first sensor to a sixth sensor for n seconds, the first plurality of data elements may refer to respective pieces of time-series data obtained from the first sensor to the sixth sensor for n seconds.

In an embodiment, the processor 124 may compare, for each data element, a first plurality of data elements and a second plurality of data elements for a particular sensor to determine whether or not a difference is present therebetween. For example, the processor 124 may compare a data element for the first sensor from among the first plurality of data elements with a data element for the first sensor from among the second plurality of data elements. Here, the processor 124 may sequentially or parallelly compare a plurality of data elements included in the first plurality of data elements and the second plurality of data elements.

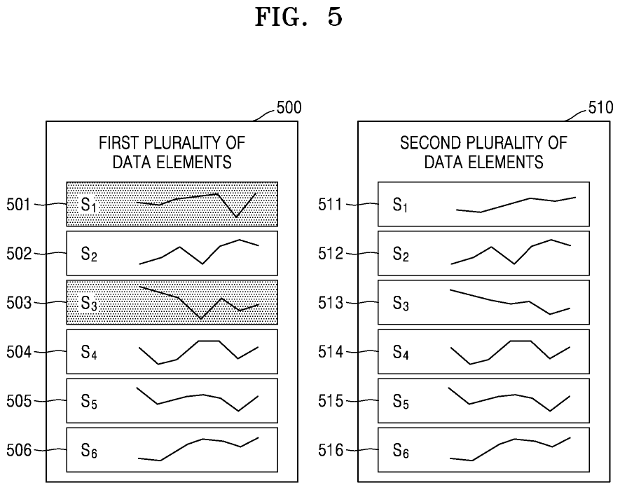

In an embodiment, the processor 124 may compare the first plurality of data elements with the second plurality of data elements on the basis of structural patterns of graphs corresponding to respective pieces of time-series data included in the first plurality of data elements and the second plurality of data elements. A detailed description thereof is described below with reference FIG. 5.

However, the method by which the processor 124 compares the first plurality of data elements with the second plurality of data elements is not limited to the comparison of the structural patterns, and in another embodiment, the processor 124 may also compare the first plurality of data elements with the second plurality of data elements on the basis of levels of sensing values.

According to an embodiment, in operation 209, the processor 124 may detect at least one data element. In other words, the processor 124 may detect at least one data element having a difference as a result of comparing, for each data element, the first plurality of data elements included in the first time-series data with the second plurality of data elements included in the second time-series data.

For example, when structural patterns of pieces of time-series data for the first sensor and the third sensor, which are included in the first plurality of data elements are not similar to structural patterns of pieces of time-series data for the first sensor and the third sensor, which are included in the second plurality of data elements, the processor 124 may detect pieces of time-series data for the first sensor and the third sensor, which are included in the first plurality of data elements.

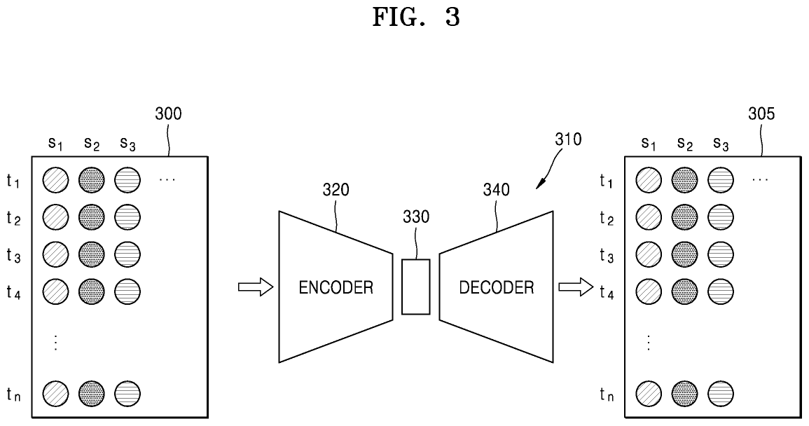

FIG. 3 illustrates an example view illustrating a method of generating an anomaly detection model, according to an embodiment.

Referring to FIG. 3, multivariate time-series data 300 may be acquired via a sensor module (e.g., the sensor module 112 of FIG. 1) in a normal state process. For example, the multivariate time-series data 300 may include data collected at a first time point t₁ by a plurality of sensors included in the sensor module 112, data collected at a second time point t₂, data collected at a third time point t₃, and data collected at an n^{th} time point tₙ. In an embodiment, a processor (e.g., the processor 124 of FIG. 1) of an analysis

apparatus (e.g., the analysis apparatus 120 of FIG. 1) may input the multivariate time-series data 300 into an auto-encoder 310. Here, the auto-encoder 310 may configure an anomaly detection model. In more detail, the auto-encoder 310 may be combined with a pre-processing module and/or a post-processing module of the anomaly detection model to configure the anomaly detection model. Alternatively, a plurality of auto-encoders 310 may be ensembled to configure the anomaly detection model.

When the multivariate time-series data 300 is input into the auto-encoder 310, an encoder 320 may perform loss compression on the multivariate time-series data 300 and a decoder 340 may perform decompression on intermediate data. The auto encoder 310 may automatically learn a method of extracting features from the multivariate time-series data 300 so that reconstructed data 305 obtained by performing decompression via the decoder 340 may be the same as the multivariate time-series data 300.

In an embodiment, a latent space 330 may include features extracted from the multivariate time-series data 300 via the auto-encoder 310.

In an embodiment, the multivariate time-series data 300 input into the auto-encoder 310 and the reconstructed data 305 output from the auto-encoder 310 may be substantially the same data. For example, when the auto-encoder 310 is trained on the basis of data acquired via the sensor module 112 in a normal state process, a reconstruction error may be substantially considerably small. Accordingly, the reconstructed data 305 may be output as substantially the same data as the multivariate time-series data 300.

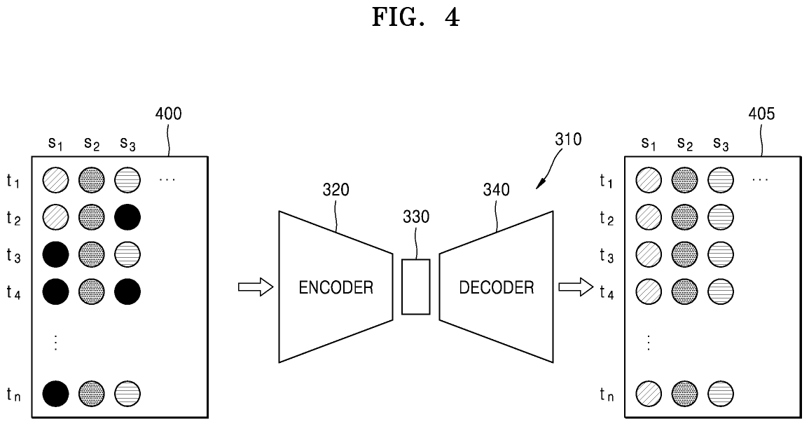

FIG. 4 illustrates an example view in which abnormal data is input into the anomaly detection model of FIG. 3.

Referring to FIG. 4, multivariate time-series data 400 may be acquired via a sensor module (e.g., the sensor module 112 of FIG. 1) in a process in which at least some of a process element and an equipment element are in an abnormal state. For example, the multivariate time-series data 400 may include abnormal data collected from a third time point t₃ by a first sensor s₁ and abnormal data collected at a second time point t₂ and a fourth time point t₄ by a third sensor s₃.

Here, the abnormal data may include a sensing value acquired differently from a previous sensing value when an error/failure occurs in a particular process element and/or a particular equipment element corresponding to a particular sensor. A process element may refer to an element (e.g., a chemical application time, an application temperature, the number of rotations of a wafer when applied) related to the progress of a particular process (e.g., a chemical application process), and an equipment element may refer to an element (e.g., a nozzle, an actuator of a nozzle arm, a motor that rotates a chuck, or the like) related to equipment involved in a particular process.

For example, when the first sensor s₁ is a temperature sensor, data collected at the third time point t₃ by the first sensor s₁ in a normal state process may include a sensing value of about 55° C., but data collected at the third time point t₃ by the first sensor s₁ in an abnormal state process may include a sensing value of about 100° C.

In an embodiment, a processor (e.g., the processor 124 of FIG. 1) of an analysis apparatus (e.g., the analysis apparatus 120 of FIG. 1) may determine, on the basis of an auto-encoder 310, whether or not the multivariate time-series data 400 includes abnormal data.

For example, when the multivariate time-series data 400 is input into the auto-encoder 310, an encoder 320 may perform loss compression on the multivariate time-series data 400 and a decoder 340 may perform decompression on intermediate data.

When extracting features while performing the loss compression on the multivariate time-series data 400, the encoder 320 of the auto-encoder 310 may extract, from the abnormal data included in the multivariate time-series data 400, a feature in which a portion of an abnormal pattern is missing. In addition, the decoder 340 of the auto-encoder 310 may output reconstructed data 405 by performing the decompression on the intermediate data on the basis of the feature in which the portion of the abnormal pattern is missing. Here, the reconstructed data 405 output by the decoder 340 may be output as normal data due to missing of the abnormal data.

In an embodiment, the processor 124 may determine whether or not the input multivariate time-series data 400 includes the abnormal data, by comparing the multivariate time-series data 400 input into the auto-encoder 310 with the reconstructed data 405 output from the auto-encoder 310. For example, the processor 124 may calculate a reconstruction error between the multivariate time-series data 400 and the reconstructed data 405, and, when the calculated reconstruction error value is greater than or equal to a reference value, determine that the multivariate time-series data 400 includes the abnormal data.

FIG. 5 illustrates an example view of a plurality of data elements included in time-series data, according to an embodiment.

Referring to FIG. 5, when first time-series data (e.g., the multivariate time-series data 400 of FIG. 4) input into an anomaly detection model is determined to include abnormal data, a processor (e.g., the processor 124 of FIG. 1) of an analysis apparatus (e.g., the analysis apparatus 120 of FIG. 1) may compare a first plurality of data elements 500 with a second plurality of data elements 510.

Here, the first plurality of data elements 500 may include respective pieces of time-series data acquired by a plurality of sensors, respectively, with respect to the first time-series data. In addition, the second plurality of data elements 510 may include respective pieces of time-series data acquired by the plurality of sensors, respectively, with respect to the second time series data (e.g., the reconstructed data 405 of FIG. 4).

For example, the first plurality of data elements 500 and the second plurality of data elements 510 may include respective pieces of time-series data acquired by a first sensor s₁ to a sixth sensor s₆, respectively. Here, the pieces of time-series data acquired by the first sensor s₁ to the sixth sensor s₆, respectively, may be in the form of graphs.

In an embodiment, the processor 124 may compare structural patterns of the pieces of time-series data acquired by the same sensor, from among the first plurality of data elements 500 and the second plurality of data elements 510.

For example, the processor 124 may determine that structural patterns of graphs 501 and 503, which are pieces of time-series data acquired by the first sensor s₁ and the third sensor s₃, from among the first time-series data are not similar to structural patterns of graphs 511 and 513 which are pieces of time-series data acquired by the first sensor s₁ and the third sensor s₃, from among the second time-series data.

For example, the processor 124 may determine that structural patterns of graphs 502, 504, 505, and 506, which are pieces of time-series data acquired by the second sensor s₂, the fourth sensor s₄, the fifth sensor s₅, and the sixth sensor s₆, from among the first time-series data are similar to structural patterns of graphs 512, 514, 515, and 516 which are time-series data acquired by the second sensor s₂, the fourth sensor s₄, the fifth sensor s₅, and the sixth sensor s₆, from among the second time-series data.

In an embodiment, the processor 124 may detect, from among the first plurality of data elements 500, the graphs 511 and 513 that are pieces of time-series data which are acquired by the first sensor s₁ and the third sensor s₃ which have dissimilar structural patterns between the first plurality of data elements 500 and the second plurality of data elements 510.

FIG. 6 illustrates a flowchart in which a system for analyzing abnormal data generates feedback data, according to an embodiment. FIG. 6 additionally illustrates operations after operation 209 of FIG. 2, the description, which corresponds to, is the same as, or is similar to the above description, may be omitted.

Referring to FIG. 6, in operation 601, a processor (e.g., the processor 124 of FIG. 1) of an analysis apparatus (e.g., the analysis apparatus 120 of FIG. 1) may calculate an abnormality cause possibility of a process element corresponding to detected at least one data element, on the basis of a database.

In an embodiment, the database may include all information related to defects that may occur in a process. The database may include factors related to the defects that may occur in the process, factors related to failures that may occur in process equipment, and all factors related to maintenance. For example, the database may include at least one of an average defect rate, an average maintenance period, an average exchange period, and average sensitivity to temperature and humidity for each of a plurality of process stages included in the process. However, the types of data included in the database are only example and may be variously changed and/or added.

In an embodiment, the processor 124 may apply data stored in the database to detected at least one data element and calculate an abnormality cause possibility of at least one of a process element and an equipment element corresponding to the data element.

For example, when the graph 511 that is time-series data for the first sensor s₁ and the graph 513 that is time-series data for the third sensor s₃ are detected from among the first time-series data (e.g., the multivariate time-series data 400 of FIG. 4) in operation 209 of FIG. 2, the processor 124 may acquire, from the database, data matching a process element corresponding to the first sensor s₁ and a process element corresponding to the third sensor s₃.

In an embodiment, the processor 124 may acquire, from the database, at least one of an average defect rate, an average maintenance period, an average exchange period, and average sensitivity to temperature and humidity which match process elements corresponding to the first sensor s₁ and the third sensor s₃. For example, the processor 124 may acquire, from the database, that the process element corresponding to the first sensor s₁ has the average defect rate of 45% and the average maintenance period of 0.5 years. As another example, the processor 124 may acquire, from the database, that the process element corresponding to the third sensor s₃ has the average defect rate of 20% and the average maintenance period of one year. Accordingly, the processor 124 may determine that an abnormality cause possibility of the process element corresponding to the first sensor s₁ is higher than an abnormality cause possibility of the process element corresponding to the third sensor s₃.

In an embodiment, the processor 124 may calculate an abnormality cause possibility of at least one of a process element and an equipment element corresponding to the detected at least one data element by applying a weight to the database. Here, from among various pieces of data included in the database, weights may be applied in order of the pieces of data that greatly affect failures of the process element and/or the equipment element. When various pieces of data affect the failure of the process element in order of the average defect rate, the maintenance period, and the average sensitivity, the processor 124 may apply a first weight to average defect rate-related data, apply a second weight to average maintenance period-related data, and apply a third weight to average sensitivity-related data. The first weight may be a value greater than the second weight, and the second weight may be a value greater than the third weight.

In an embodiment, the processor 124 may calculate an abnormality cause possibility of at least one of a process element and an equipment element corresponding to detected at least one data element, on the basis of at least one piece of data acquired from the database. For example, the processor 124 may acquire, from the database, that the process element corresponding to the first sensor s₁ has the average defect rate of 45% and the average maintenance period of 0.5 years, input the acquired numerical values (i.e., 45% and 0.5 years) into a separate equation, and calculate an abnormality cause possibility (e.g., 60%). As another example, the processor 124 may acquire, from the database, that the process element corresponding to the third sensor s₃ has the average defect rate of 20% and the average maintenance period of 1 year, input the acquired numerical values (i.e., 20% and 1 year) into the separate equation, and calculate an abnormality cause possibility (e.g., 36%).

According to an embodiment, in operation 603, the processor 124 may determine whether or not the calculated abnormality cause probability is greater than or equal to a reference value.

For example, when the reference value is set to 30% by applying a substantially strict determination criterion to a status of a failure of a process element, the processor 124 may determine that the abnormality cause probability (e.g., 60%) of the process element corresponding to the first sensor s₁ and the abnormality cause probability (e.g., 36%) of the process element corresponding to the third sensor s₃ are each greater than or equal to the reference value.

As another example, when the reference value is set to 60% by applying a substantially accurate determination criterion the status of the failure of the process element, the processor 124 may determine that only the abnormality cause probability (e.g., 60%) of the process element corresponding to the first sensor s₁ is greater than or equal to the reference value.

According to an embodiment, in operation 605, the processor 124 may generate and output feedback data regarding the detected at least one data element.

In an embodiment, the processor 124 may generate feedback data regarding a data element having an abnormality cause probability greater than or equal to the reference value. For example, when the reference value for the abnormality cause possibility of the process element is 30%, the processor 124 may generate feedback data regarding the process element corresponding to the first sensor s₁ and the process element corresponding to the third sensor s₃. As another example, when the reference value for the abnormality cause possibility of the process element is 60%, the processor 124 may generate feedback data regarding the process element corresponding to the first sensor s₁.

In an embodiment, the feedback data may include at least one of whether or not at least one of a process element and an equipment element is abnormal and management information of the at least one of the process element and the equipment element. Here, the management information may refer to information related to management of the process element and the equipment element detected as being abnormal, and may include, for example, calibration period information of the process element, replacement period information of the equipment element, and the like.

In an embodiment, the processor 124 may output, via a user interface (not shown), the feedback data generated with respect to the detected at least one data element. The user interface (not shown) may be a display that visually outputs the feedback data regarding the detected at least one data element, may be a haptic module that converts the feedback data into mechanical or electrical stimulation and tactilely outputs the mechanical or electrical stimulation, or may be a sound module that audibly outputs the feedback data. However, the type of user interface is not limited thereto.

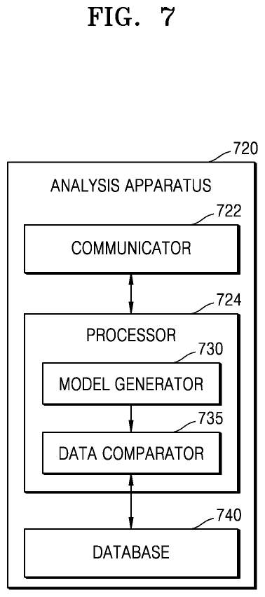

FIG. 7 illustrates a block diagram of an apparatus for analyzing abnormal data, according to an embodiment.

Referring to FIG. 7, an apparatus 720 (hereinafter, referred to as an analysis apparatus 720) for analyzing abnormal data may include a communicator 722, a processor 724, and a database 740. The communicator 722 and the processor 724 of FIG. 7 may correspond to the description of the communicator 122 and the processor 124 of FIG. 1, and thus, the corresponding or same description thereof may be omitted.

In an embodiment, the communicator 722 may include at least one component for receiving data by establishing communication with the outside. For example, the analysis apparatus 720 may receive multivariate time-series data generated by a detection apparatus (e.g., the detection apparatus 110 of FIG. 1) via the communicator 722.

In an embodiment, the processor 724 may include a model generator 730 that generates an anomaly detection model and a data comparator 735 that detects abnormal data by comparing data. Here, the model generator 730 and the data comparator 735 may be distinguishably illustrated in FIG. 7 to describe that an operation of generating an anomaly detection model within at least one processor 724 and an operation of detecting abnormal data by comparing data may be performed independently. However, the disclosure is not limited thereto, and the processor 724 may also include separate hardware corresponding to each of the model generator 730 and the data comparator 735.

In an embodiment, the processor 724 may generate an anomaly detection model via the model generator 730. For example, when a plurality of pieces of multivariate time-series data are received from the outside (e.g., the detection apparatus 110) via the communicator 722, the processor 724 may generate the anomaly detection model by training a network function by using a training data set including the plurality of pieces of multivariate time-series data that are received. Here, the training data set including the plurality of pieces of multivariate time-series data received via the communicator 722 may be a data set acquired via the detection apparatus 110 when a process is in a normal state.

In an embodiment, the processor 724 may perform, via the data comparator 735, a comparison operation between various types of data. For example, the processor 724 may perform a three-stage data comparison operation via the data comparator 735.

In the first stage, the processor 724 may compare first time-series data, which is input data for the anomaly detection model generated by the model generator 730 with second time-series data which is output data from the anomaly detection model.

In the second stage, the processor 724 may compare data for respective data elements included in each of the first time-series data determined to include abnormal data and the second time-series data output from the anomaly detection model.

In the third stage, with respect to a data element determined to have a difference as a result of comparing the respective data elements, the processor 724 may calculate an abnormality cause probability of the data element on the basis of data included in the database 740, and compare the calculated abnormality cause probability with a reference value.

However, the operation of performing the data comparison operation by the processor 724 is not limited to the three stages, and in another embodiment, the processor 724 may perform the data comparison operation by dividing the data comparison operation into a plurality of operations (e.g., four or more operations) through a design change.

In an embodiment, the processor 724 may generate feedback data on the basis of the result of the comparison operation performed via the data comparator 735. For example, if an abnormality cause possibility for a particular data element calculated by the data comparator 735 is greater than or equal to a reference value, the processor 724 may generate and output feedback data regarding the data element.

A system for analyzing abnormal data, according to the spirit of the disclosure, may detect that input data includes abnormal data, on the basis of a difference between input and output data for an anomaly detection model, as well as identify whether or not data corresponding to any element from among a plurality of elements included in the input data is abnormal data, and thus may accurately monitor a process element and an equipment element that need maintenance.

In addition, the system for analyzing abnormal data, according to the spirit of the disclosure, may guide a user to appropriately maintain the process element and/or the equipment element by analyzing the abnormal data and monitoring the process element and the equipment element that need maintenance.

However, effects of the embodiments are not limited to the above-described effects, and effects not mentioned may be clearly understood by one of ordinary skill in the art to which the embodiments belong from the description and the accompanying drawings.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An operating method of a system for analyzing abnormal data, the operating method comprising:
generating an anomaly detection model by using a training data set including a plurality of pieces of multivariate time-series data;
comparing first time-series data input to the anomaly detection model with second time-series data output from the anomaly detection model through an operation on the first time-series data;
determining whether or not the first time-series data includes abnormal data, on the basis of the comparison between the first time-series data and the second time-series data;
when the first time-series data is determined to include the abnormal data, comparing a first plurality of data elements included in the first time-series data with a second plurality of data elements included in the second time-series data; and
detecting at least one data element on the basis of a result of comparing the first plurality of data elements with the second plurality of data elements.

2. The operating method of claim 1, wherein the first plurality of data elements and the second plurality of data elements each include a plurality of time-series data respectively acquired by a plurality of sensors in a process.

3. The operating method of claim 1, further comprising calculating, on the basis of a database related to the process, an abnormality cause possibility of at least one of a process element and an equipment element corresponding to the detected at least one data element.

4. The operating method of claim 3, wherein the database includes at least one of an average defect rate, an average maintenance period, an average exchange period, and average sensitivity to temperature and humidity for each of a plurality of process operations.

5. The operating method of claim 3, further comprising calculating the abnormality cause probability for the detected at least one data element by applying a weight to the database.

6. The operating method of claim 3, further comprising generating and outputting feedback data regarding the detected at least one data element when the calculated abnormality cause probability is greater than or equal to a reference value.

7. The operating method of claim 6, wherein the feedback data includes at least one of whether or not at least one of the process element and the equipment element corresponding to the detected at least one data element is abnormal and management information regarding at least one of the process element and the equipment element.

8. The operating method of claim 1, wherein the determining of whether or not the first time-series data includes the abnormal data includes determining that the first time-series data includes the abnormal data, when a reconstruction error calculated on the basis of the comparison between the first time-series data and the second time-series data is greater than or equal to a reference value.

9. A system for analyzing abnormal data, the system comprising:
a detection apparatus configured to generate, in a process, multivariate time-series data via a plurality of sensors; and
an analysis apparatus including at least one processor, wherein the processor is configured to: generate an anomaly detection model by using a training data set including a plurality of pieces of multivariate time-series data; compare first time-series data, which is generated via the detection apparatus and input to the anomaly detection model, with second time-series data output from the anomaly detection model through an operation on the first time-series data; determine whether or not the first time-series data includes abnormal data, on the basis of the comparison between the first time-series data and the second time-series data; when the first time-series data is determined to include the abnormal data, compare a first plurality of data elements included in the first time-series data with a second plurality of data elements included in the second time-series data; and detect at least one data element on the basis of a result of comparing the first plurality of data elements with the second plurality of data elements.

10. The system of claim 9, wherein the first plurality of data elements and the second plurality of data elements include a plurality of time-series data respectively acquired by a plurality of sensors of the detection apparatus in a process.

11. The system of claim 9, wherein the processor is further configured to calculate, on the basis of a database related to the process, an abnormality cause possibility of at least one of a process element and an equipment element corresponding to the detected at least one data element.

12. The system of claim 11, wherein the database includes at least one of an average defect rate, an average maintenance period, an average exchange period, and average sensitivity to temperature and humidity for each of a plurality of process operations.

13. The system of claim 11, wherein the processor is further configured to calculate the abnormality cause probability for the detected at least one data element by applying a weight to the database.

14. The system of claim 11, wherein the processor is further configured to generate and output feedback data regarding the detected at least one data element when the calculated abnormality cause probability is greater than or equal to a reference value.

15. The system of claim 9, wherein the processor is further configured to determine the first time-series data to be abnormal data when a reconstruction error calculated on the basis of the comparison between the first time-series data and the second time-series data is greater than or equal to a reference value.

16. An apparatus for analyzing abnormal data, the apparatus comprising:
a communicator configured to receive data by establishing communication with outside; and
at least one processor, wherein the processor is configured to: generate an anomaly detection model by using a training data set including a plurality of pieces of multivariate time-series data; input first time-series data received via the communicator to the anomaly detection model, and acquire second time-series data output from the anomaly detection model through an operation on the first time-series data; determine whether or not the first time-series data includes abnormal data, on the basis of comparison between the first time-series data and the second time-series data; when the first time-series data is determined to include the abnormal data, compare a first plurality of data elements included in the first time-series data with a second plurality of data elements included in the second time-series data; and detect at least one data element on the basis of a result of comparing the first plurality of data elements with the second plurality of data elements.

17. The apparatus of claim 16, wherein the processor is further configured to
calculate, on the basis of a database related to a process, an abnormality cause possibility of at least one of a process element and an equipment element corresponding to the detected at least one data element.

18. The apparatus of claim 17, wherein the database includes at least one of an average defect rate, an average maintenance period, an average exchange period, and average sensitivity to temperature and humidity for each of a plurality of process operations.

19. The apparatus of claim 17, wherein the processor is further configured to generate and output feedback data regarding the detected at least one data element when the calculated abnormality cause probability is greater than or equal to a reference value.

20. The apparatus of claim 16, wherein the processor is further configured to determine the first time-series data to be abnormal data when a reconstruction error calculated on the basis of the comparison between the first time-series data and the second time-series data is greater than or equal to a reference value.
